(19) United States
(12) Patent Application Publication
(10) Pub. No.: US 2002/0107744 A1
(43) Pub. Date: Aug. 8, 2002

(54) Item dispenser and user interface

(75) Inventors: Dean G. Rosenberg, San Diego, CA (US); William K. Holmes, San Diego, CA (US)

Correspondence Address: MICHAEL BEST & FRIEDRICH, LLP, 100 E WISCONSIN AVENUE, MILWAUKEE, WI, 53202, US

(73) Assignee: SupplyPro, Inc., San Diego, CA

(21) Appl. No.: 10/008,621

(22) Filed: Oct. 22, 2001

Related U.S. Application Data
(60) Provisional application No. 60/241,894, filed on Oct. 20, 2000.
(60) Provisional application No. 60/242,417, filed on Oct. 23, 2000.

(51) Int. Cl. G06F 17/60

(52) U.S. Cl. 705/18

(57) ABSTRACT

A method of monitoring inventory within a dispensing cabinet. The method includes using different treatment of allocation codes, web-based special ordering, considered consumed check in check out function, find item function for searching different locations, defective item return function, market research function, quota function, and consignment function.

### CROSS-REFERENCE TO RELATED APPLICATIONS

This application claims priority under 35 U.S.C. §119 to United States provisional patent application serial no. 60/241,894, filed on Oct. 20, 2000 and United States provisional application serial no. 60,242,417, filed on Oct. 23, 2000.

### FIELD OF THE INVENTION

The invention relates to an item dispenser, a dispenser user interface, and varying dispenser configurations for dispensing items from said item dispenser.

### SUMMARY OF THE INVENTION

The dispenser of the present invention is designed to dispense a wide variety of items, such as but not limited to, office supplies, manufacturing tools, raw materials for product production, safety supplies, manuals, etc. The dispenser enables, inter alia, access to the items being dispensed, monitoring of inventory levels, consumption and maintenance, and ordering of items when needed regardless of the type of item being dispensed.

The dispenser interface is preferably of a kiosk design taking advantage of user interface technology, including graphics, audio, and video.

The dispenser can also be configured to control item dispensing, monitor access, and monitor quantity taken or returned. Various dispenser configurations are disclosed herein for these purposes.

Other features and advantages of the invention will become apparent to those of ordinary skill in the art upon review of the following detailed description and drawings.

### BRIEF DESCRIPTION OF THE DRAWINGS

FIG. 1 is an example of a log on screen of the user interface;

FIG. 2 is an example of an administration log on screen;

FIG. 3 is an example of an allocation code screen;

FIG. 4 is an example of another allocation code screen;

FIG. 5 is a flowchart and screen examples relating to the take/return function;

FIG. 6 is an example of a take/return item menu screen;

FIG. 7 is an example of a check-in/check-out screen;

FIG. 8 is a flowchart and screen examples relating to the check-out function;

FIG. 9 is a flowchart and screen examples relating to the check-in function;

FIG. 10 is a flowchart of the find item function;

FIG. 11 is an example of a find item screen;

FIG. 12 is an example of a search elsewhere screen;

FIG. 13 is an example of a find kit screen;

FIG. 14 is a flowchart and screen example relating to the defective item return function;

FIG. 15 is a flowchart and screen example relating to the remove defective item function;

FIG. 16 is a flowchart and screen example relating to the inventory function;

FIG. 17 is an example of an inventory screen;

FIG. 18 is a flowchart and screen examples relating to the refill function;

FIG. 19 is an example of a refill purchase order screen;

FIG. 20 is a flowchart and screen examples relating to the load pocket function;

FIG. 21 is a flowchart and screen example relating to the unload pocket function;

FIG. 22 is an example of an unload pocket screen;

FIG. 23 is a flowchart of the move pocket function;

FIG. 24 is an example of a move inventory screen;

FIG. 25 is an example of a request service screen; and

FIG. 26 is an example of a help screen.

Before one embodiment of the invention is explained in detail, it is to be understood that the invention is not limited in its application to the details of construction and the arrangement of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

### DESCRIPTION OF THE PREFERRED EMBODIMENT

The invention includes a dispenser for dispensing items. The dispenser includes a user interface so that a user can access dispenser functions. The interface is preferably of a kiosk design taking advantage of user interface technology, including graphics, audio, and video, however, other types of interfaces which include the various functions described below can also be utilized. The function specification of the dispenser and interface are as follows.

It should be noted that in the functional specification section below, the functions are explained with respect to a conventional take/return button approach in which the user indicates if items are taken or returned from the dispenser by pushing appropriate buttons and locked doors are used to control access to the items. As will be readily apparent to those of ordinary skill in the art, other approaches in addition to the take and return buttons and locked doors can be used with the interface.

A. Functional Specification

Depending upon the items to be dispensed, all of the functions set forth and described below may not be necessary in a given dispenser. The functions can be incorporated into the dispenser and interface as a given application requires.

1. General Usability

The dispenser of the present invention includes a graphical user interface and is preferably positioned as a kiosk. A touch screen is the primary input for all user activities, with use of a keyboard preferably minimized. Media elements such as graphical icons, audio, and video are employed to support ease of use and provide users a positive user experience. The interface is designed to allow users to self-train for common functions, and therefore does not require training prior to use.

The dispenser supports both modem and Internet connectivity, however, functionality is enhanced if Internet connectivity is activated. As is more fully set forth in application Serial No. 476,536, filed on Jan. 3, 2000, titled METHOD AND SYSTEM FOR PROVIDING ON-LINE INVENTORY AND DISPENSING THROUGH A DISTRIBUTED NETWORK, which is hereby incorporated by reference, dispensers that are connected to the Internet or local intranet will allow users to access web-based functions such as browsing and searching other dispensers.

2. Log On Function

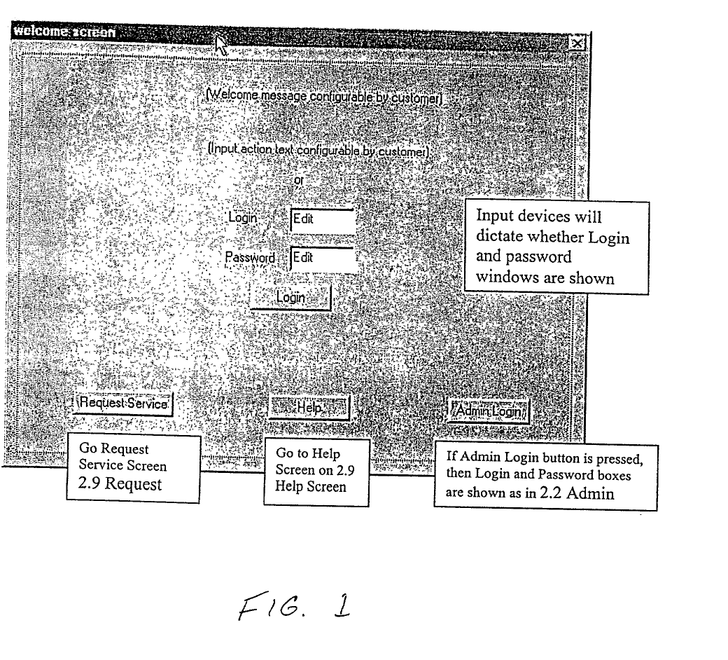

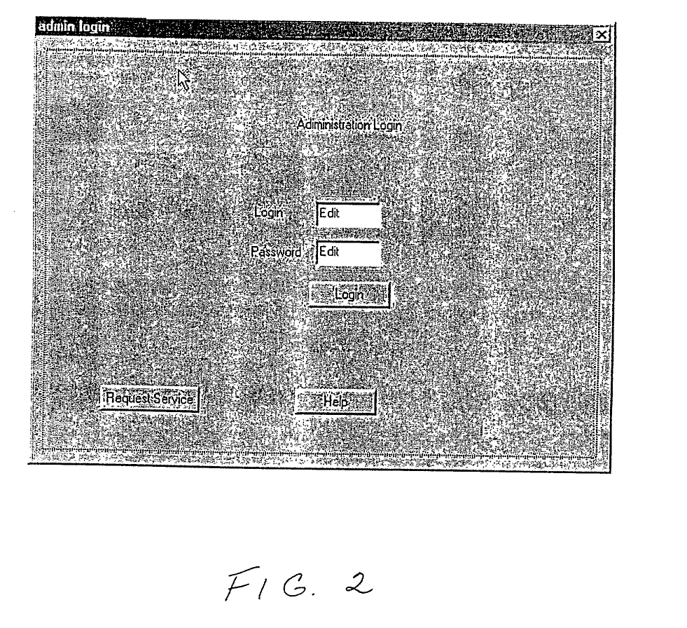

A log on screen allows users to identify themselves using either a user name and password, or a security badge. New users are able to view a training video on the screen which introduces them to the dispenser and demonstrates dispenser use. Examples of log on screens are illustrated as FIGS. 1 and 2.

Preferably, the log on function includes one or more of the following: (1) provide support for Wiegand and serial input devices, including HID and Casi-Rusco proximity readers, (2) provide support for existing programmable ID Tech bar code and magnetic strip readers without requiring keyboard wedge approach, (3) if an input device is used, allow system administrator to optionally log in with user name and password using the keyboard, (4) support expanded fields for user name and password, such as up to 20 characters, (5) support access through a standard consumer credit card, (6) record log on failures and transmit to server for monitoring or reporting, and (7) offer how-to video to new users.

3. Controlled Access Function

The dispenser and interface support an unlimited number of dispenser configurations so as to allow for selective lockout of different users. Once a user has successfully logged on, all applicable security will unlock. An optional reminder message will audibly alert the user to press the take button once for each item removed. As set forth above, the take/return button approach will be described herein, while it should be kept in mind that other access approaches known to those of ordinary skill in the art, such as those set forth in Section C, can also be employed.

Preferably, the controlled access function includes one or more of the following: (1) support of unlimited number of door configurations for each dispenser, (2) support the ability to assign door configurations to specific users or user groups, (3) unlock only applicable doors after log on, (4) support a configurable audio message for pressing the take button and reminding users to close open doors if left open after quitting or time-out, and (5) automatically exit the current activity and lock all doors after a configurable time period has elapsed with the time period specific to each dispenser being configurable.

The interface will also support group-based security functionality. Group-based security enables users to be assigned to a user group that is assigned a specific subset of privileges. Depending on the privileges available to an individual user, specific functions within the dispenser may be disabled or otherwise unavailable to the user.

4. Dispensing Allocation Code Function

The dispenser and interface support allocation codes, which allow customers to track consumption against customer specific tracking codes. In other words, a customer (e.g., a company that purchases and implements the system and method of the present invention) can track inventory and regulate its consumption based on the product in inventory and the user (e.g., employee of the company) using the product. Allocation codes can be defined at a number of different levels. Login allocation codes are prompted immediately after a user logs in to the dispenser and apply to the entire session. Examples of login allocation codes are cost center, department, and work order number. Product allocation codes allow customers to track consumption of individual items removed from the dispenser. The interface will prompt the user to enter product allocation codes immediately after an item has been removed. Examples of product allocation codes include item serial number, lot number, and equipment number. In this way, a customer can regulate the inventory on-hand of a particular product based on its serial number, lot number, equipment number, etc.

For each allocation code, the interface is configured to prompt the user to select a code from a list, type in the code directly, or be automatically assigned based on a default value stored in the user's profile. If manual entry is enabled, then the code typed by the user can be subject to customer-defined validation. Allocation codes can be defined as one of the following types: text, text list, numeric, date, and yes/no. An allocation code defined as a text list will be displayed as a scrollable list of values on the interface.

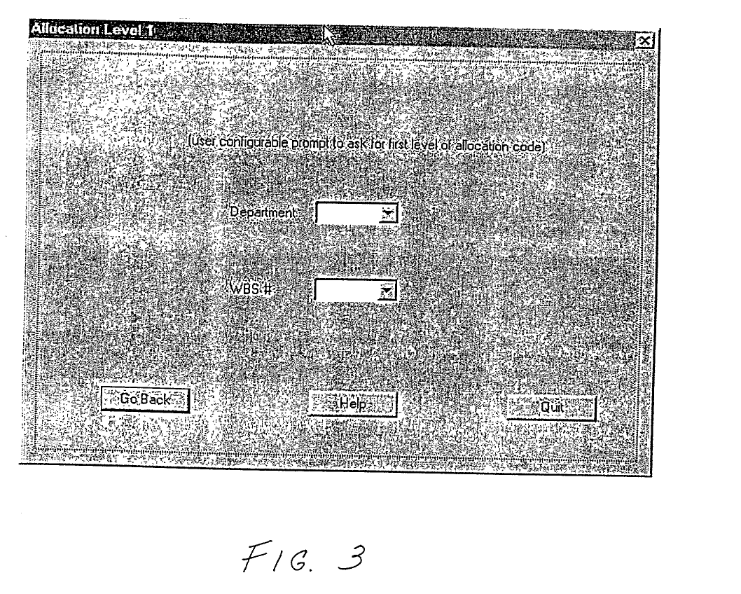

Login allocation codes are prompted immediately after the user logs on and before the items are available for removal, for example as shown in the screen example of FIG. 3. Each login allocation code is pre-defined with the following attributes: “Type,” “Required,” and “Validation.” The “Type” attribute includes text (any alphanumeric value), text list (an entry prompted from a list of valid values), numeric (a numeric value), date (any date), and yes/no. The “Required” attribute includes a flag indicating whether the allocation code is required. If not, the code may be left blank when the user is prompted. The “Validated” attribute includes validating the entry against a list of valid values.

Login allocation codes are preferably defined at the company level. Thus, the same login allocation codes will be displayed across all dispensers in a given company. This allows for uniform reporting of consumption and other user activity by login allocation codes. Preferably, the dispenser enables default login allocation codes to be configured for individual users. Default allocation codes can be configured to force the user to use the code, or can simply suggest the code as a default, but allow the user to select a different code when prompted.

Preferably, the login allocation code function includes one or more of the following: (1) prompt user for multiple login allocation codes immediately after log in, (2) for each allocation code, display a customer-specific label, (3) constrain input depending on the type defined for the allocation code, if the type is a text list then allow the user to select from a list of valid entries, (4) for allocation codes of type text, validate against a list of values after user entry if the “Validated” attribute is set and if a valid value is not entered, notify the user and allow the user to re-enter a valid value, (5) do not allow a blank value if the “Required” attribute is set, and (6) display the user-specific default value for an allocation code if a default value has been provided in the user's profile and if a default value is designated as forced, then assign the user's default value to the allocation code, but do not display a prompt for the allocation code.

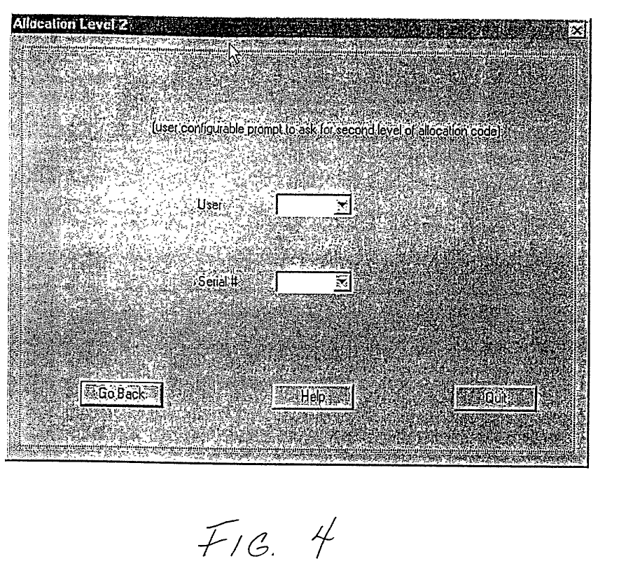

The product allocation codes are prompted immediately after a user removes an item such as by pressing a take button, as shown in the screen example of FIG. 4. Each product allocation code is preferably defined at the item level, meaning that consumption of different items can result in the prompting of different product allocation codes. Default product allocation codes can also be defined at the customer level. The customer-level codes are preferably prompted whenever item specific allocation codes are not defined for a given item. For example, if an item is a carbon steel hex bolt, the interface may be configured to prompt the user for a lot number each time a bolt is removed.

For each item in the dispenser, it is possible to configure different product allocation codes for each of the following events: item is consumed, item is returned, item is borrowed from a check-out pocket (as will be discussed below), and item is returned to a defect pocket (as well be described below).

The product allocation codes can be configured as a batch allocation code or a unit allocation code. A batch allocation code can be applied to one or more items. A unit allocation code is prompted for each individual unit that is removed from the dispenser. For example, a unit allocation code of “serial number” will require the user to enter a serial number for each item that is removed (e.g. each time the take button is pressed). Preferably, only one product allocation code can be designated as a unit allocation code for each item.

Product allocation codes have the same attributes as the login allocation codes described above. Further, the product allocation code function includes one or more of the following: (1) prompt the user for multiple allocation codes immediately after log in, (2) for each allocation code, display a customer-specific label, (3) constrain input depending on the type defined for the allocation code, if the type is text list, then allow the user to select from a list of valid entries, (4) for allocation codes of type text, validate against a list of values after user entry if the “Validated” attribute is set and if a valid value is not entered, notify the user and allow the user to re-enter a valid value, (5) do not allow a blank value if the “Required” attribute is set, (6) after an item is removed, prompt the user for a quantity if all defined product allocation codes are configured as batch allocation codes, (7) only allow the take and return buttons to be pressed once if any product allocation code is configured as a unit allocation code, and (8) prompt for default product allocation codes if no product allocation codes are defined at the item level for a specific item.

The allocation codes can be programmed by the customer (i.e., the company or its representative—president, manager, etc.) at the point-of-use. That is, according to the present invention, the system allows the company president, for example to walk up to an item dispenser and reconfigure the allocation codes for a particular user or product. For example, if the customer wants to give a particular employee (i.e., user) increased access to a particular product, the customer can reconfigure the entire system of item dispensers from a point-of-use (i.e., one of the dispensers). Similarly, the customer can reconfigure the allocation codes for a particular product. For example, if the president of the company wants to regulate the amount of pens used by his or her employees, he or she can set an allocation code allowing only a certain amount of pens to be dispensed from the dispenser. The system allows the customer to reconfigure allocation codes from the point-of-use and on-the-fly. Put another way, the reconfiguration does not need to be performed at the main data center, but can instead be programmed at an item dispenser, which then registers the new allocation code for the system. The customer can update already set allocation codes or can create entirely new codes as needed. The customer is not restrained to any preconceived set of data fields.

5. Consumption Display and Printing Function

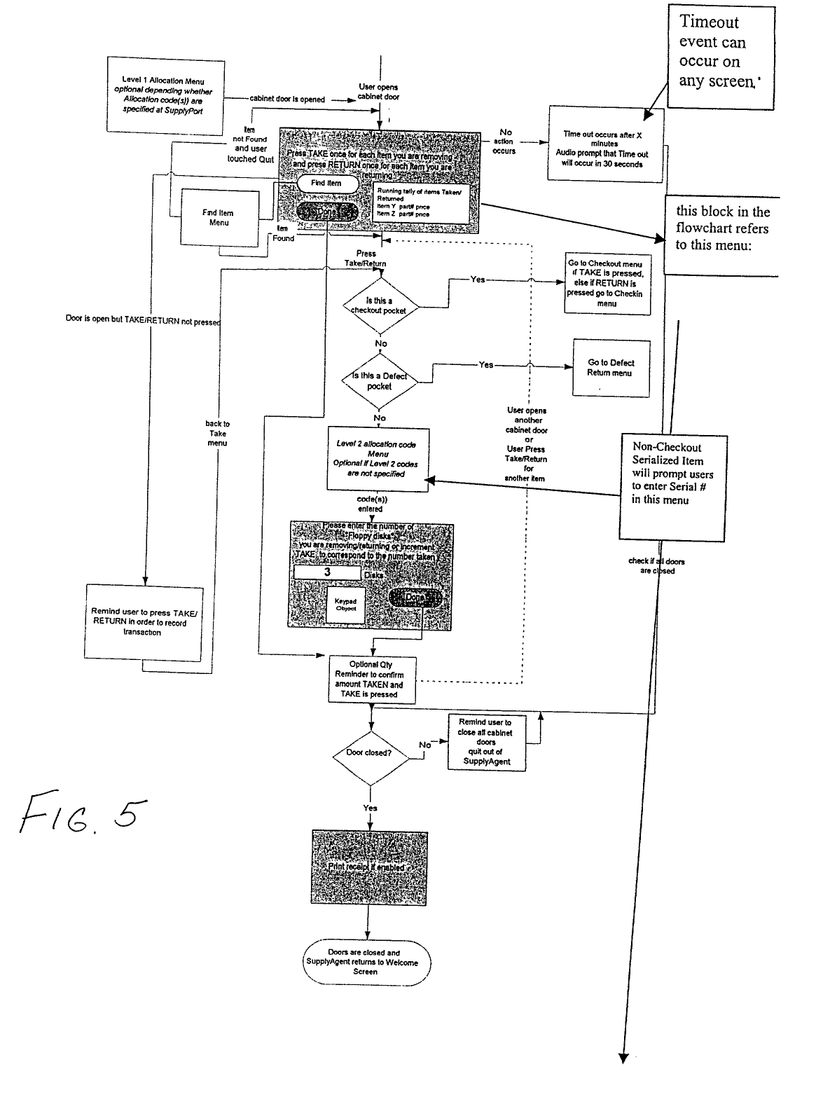

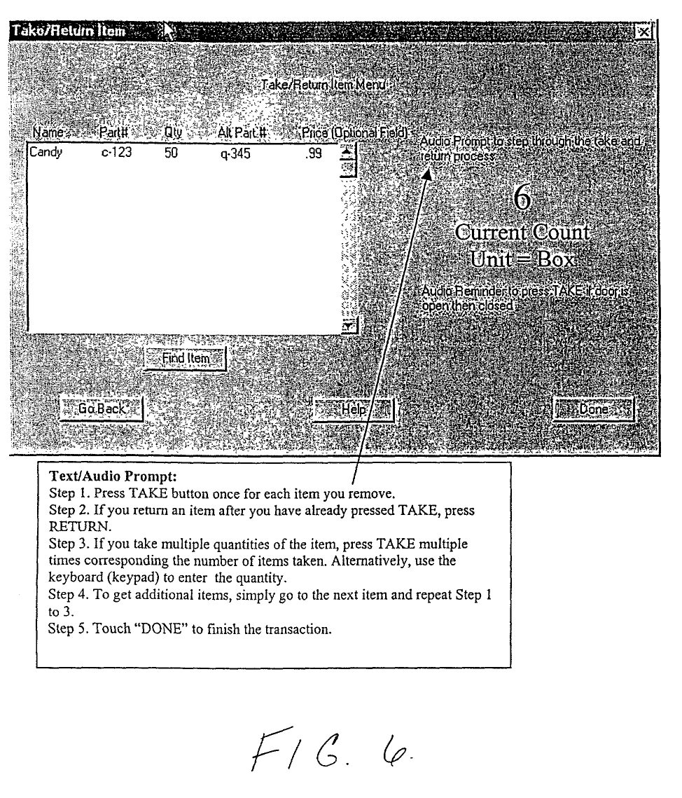

Every time a door is opened, the interface prompts the user to “Press the take button for every item removed”. This prompt will be accompanied with an optional audible reminder. When the take or return button is pressed, if the unit of issue is not “each”, then the unit of issue is displayed to ensure that items are dispensed correctly (e.g., an audible reminder stating “Please press the take button once for every box you remove”). Examples of screens for this function are illustrated in FIGS. 5 and 6.

The dispenser enables the display of a running list of all items taken or returned in a session. The list indicates the name, part number, and quantity consumed for each item. On a customer-defined basis, the list can also be configured to display alternate part number, price, extended price, and total amount.

Preferably, the consumption function includes one or more of the following: (1) prompt the user to press the take button as soon as the first door is opened, (2) display a message reminding the user to take by the stated unit of issue, (3) if a door is closed and no take or return button has been pressed, remind the user to press the take button with an optional audible reminder, (4) display a list of all consumption and returns during a session, the display properties of the list should be configurable to support alternate part number and price, (5) support a sales tax rate that will apply to each dispenser to support printing of a point-of-sale receipt, (6) allow for the generation of a printed receipt with information matching the on-screen data, (7) enable sending an e-mail of receipt to the user's e-mail address, the e-mail receipt displaying all information contained on the printed receipt, (8) configurable quantity reminder to show items removed, (9) configurable confirm count function prior to removing items for items that need accurate inventory, and (10) support use of a barcode scanner to read any serial numbers on items.

6. Item Check-Out and Check-In Function

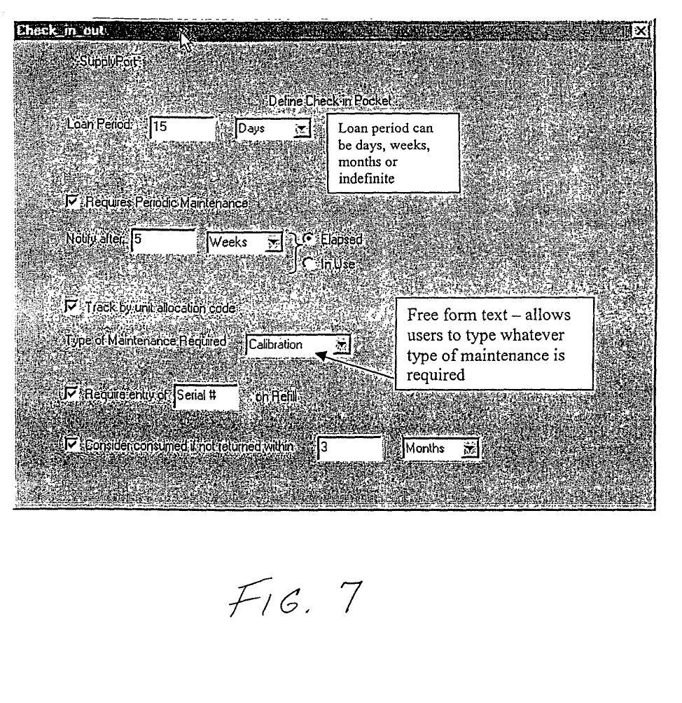

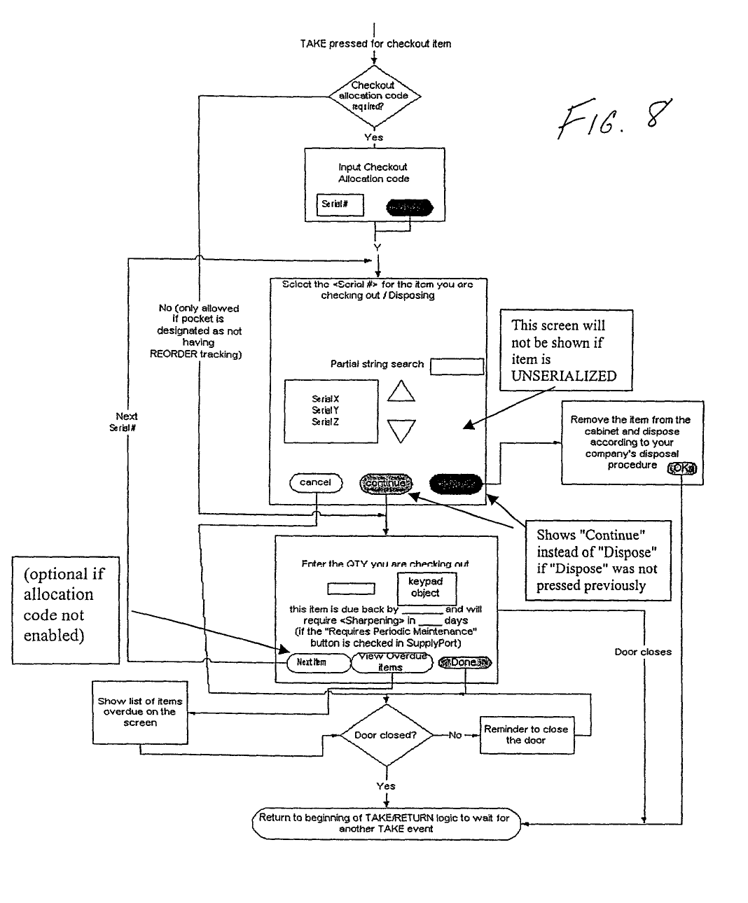

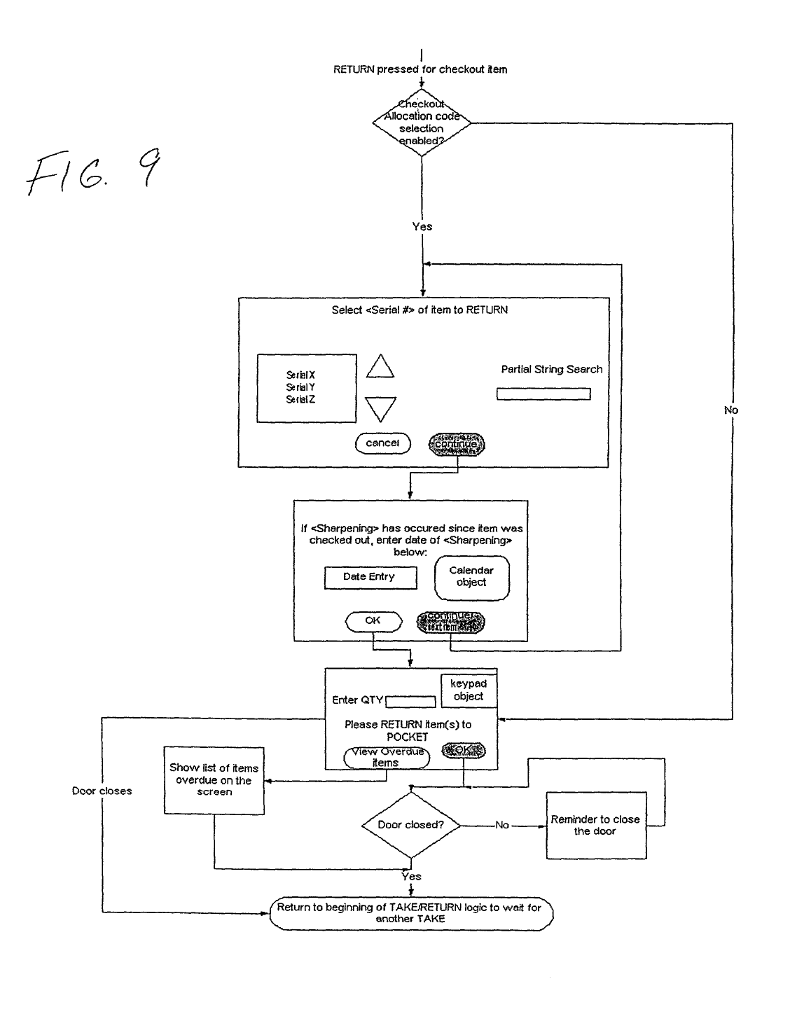

Dispensers can support check-out and check-in of items such as tools, manuals, or other materials suitable for loaning. Items designated for check-out differ from standard items. Each check-out item is assigned a loan period. Items removed and not returned within the designated loan period will be considered late. Items checked out will not be included in standard dispenser consumption reports. Check-out items can be tracked for periodic maintenance by specific unit allocation codes. Point-of-sale functionality is disabled for items having check-out properties. A notification is sent to users of overdue items as soon as the user logs in. Referring to FIGS. 7-9, examples of screens and flowcharts are illustrated for this function.

Check-out items have an associated loan period that can be defined in hours, weeks, or months, or can be designated as indefinite. When a loan period other than indefinite is configured, then the due date will be indicated on the screen every time a check-out item is removed. E-mail reminders and reports on delinquent users who have items on loan beyond the designated return date can be prepared.

A check-out item can be considered consumed after a customer-pre-defined configurable time period has elapsed. For example, if the loan period for a hammer is one week, then the hammer may be considered consumed after three weeks. If a user withdraws the hammer from the dispenser, it will be considered late after it has been out of the dispenser for one week. However, after three weeks, the dispenser will assume that the hammer has been consumed (e.g. damaged, lost, permanently relocated) and will no longer expect the item be returned to the dispenser.

Preferably, the check-out/check-in function includes one or more of the following: (1) if a loan period is configured for a check-out item, indicate the due date to the user when the item is removed from the dispenser, (2) allow a consumed threshold to be defined with items checked-out but not checked-in, (3) when a check-out item is returned to the dispenser, change the status of the item to checked-in so that the dispenser no longer designates that the item is checked out to a specific user, and (4) a user may indicate that a check-out item has been consumed to prevent delinquency notices from being sent and to update the database so that the checked out item is no longer expected by the system.

Check-out items can also be configured in the dispenser to indicate when periodic maintenance is required. The following attributes are preferably used: maintenance required flag, track by unit allocation code flag, maintenance period (specified in elapsed time or number of uses) and type of maintenance required (e.g. inspection, calibration, disposal, etc.).

When a check-out item is configured to require periodic maintenance, the dispenser will prompt the user to perform the maintenance whenever the maintenance period elapses. If the track by unit allocation code flag is set, the user will be prompted to enter a designated product allocation code every time an item is checked out, checked in, or refilled. For example, if the flag is set and a unit allocation code of “Serial Number” is defined for the item, then the interface dispenser will prompt the user to enter a serial number each time an item is removed from or returned to the dispenser. This flag must be set for check-out items that require periodic maintenance.

Preferably, the maintenance function includes one or more of the following: (1) if periodic maintenance is configured for a check-out item, display maintenance information each time an item is removed from or returned to a dispenser, information should include the date of the last maintenance, and the date that maintenance will be required, (2) if maintenance is past due, notify the user on check-out or check-in of the item and/or prevent that item from being removed, (3) allow user to indicate that maintenance has been performed when an item with a defined unit allocation code is returned to the dispenser, and (4) track maintenance schedules by the unit allocation code defined in the dispenser for the check-out item.

7. Find Item Function

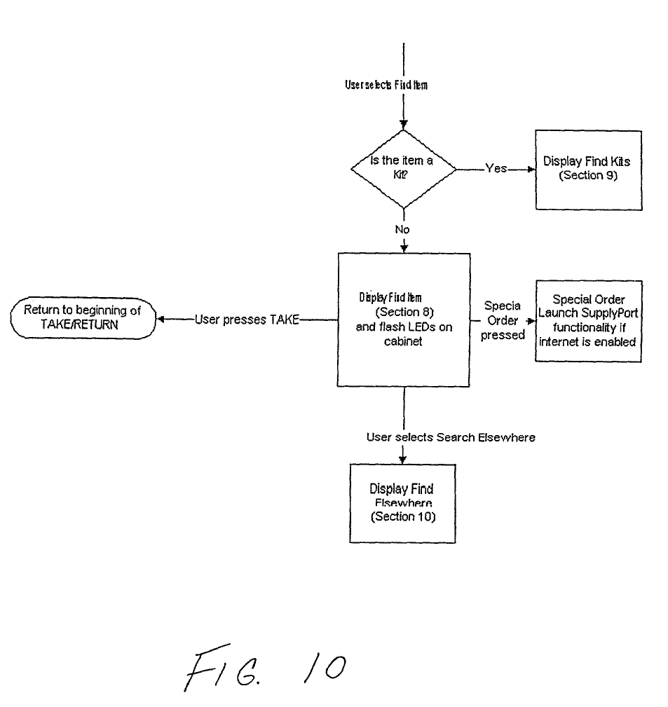

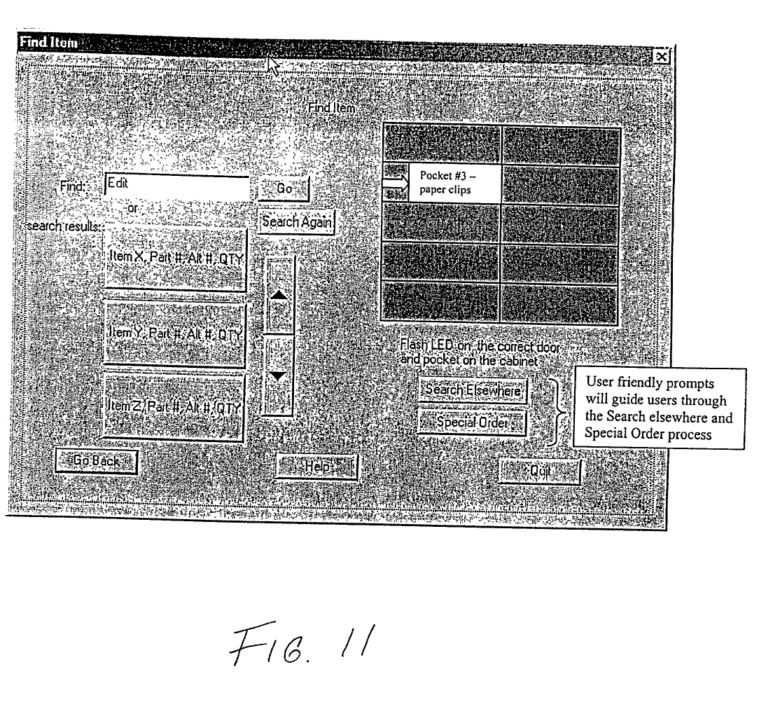

To find items in the dispenser, users are able to enter a substring associated with an item name, description, part number, or alternate part number. If more than one item matches the entry, then the user will be prompted to select an item from a list. Once an item is selected, the display will change to a graphical image of the dispenser and will highlight the location of the item. Preferably, the physical location of the item will flash. Examples of a flowchart and screens for this function are illustrated as FIGS. 10 and 11.

Preferably, the find function includes one or more of the following: (1) support of item search by item name, description, part number, or alternate part number, (2) prompt user to select an item from a scrolling list if more than one item matches the search criteria, (3) display a graphical indication of the item location in the dispenser on the screen display, (4) flash the correct location such as on a door or pocket, and (5) prompt the user to find elsewhere or special order if the item is not in the dispenser.

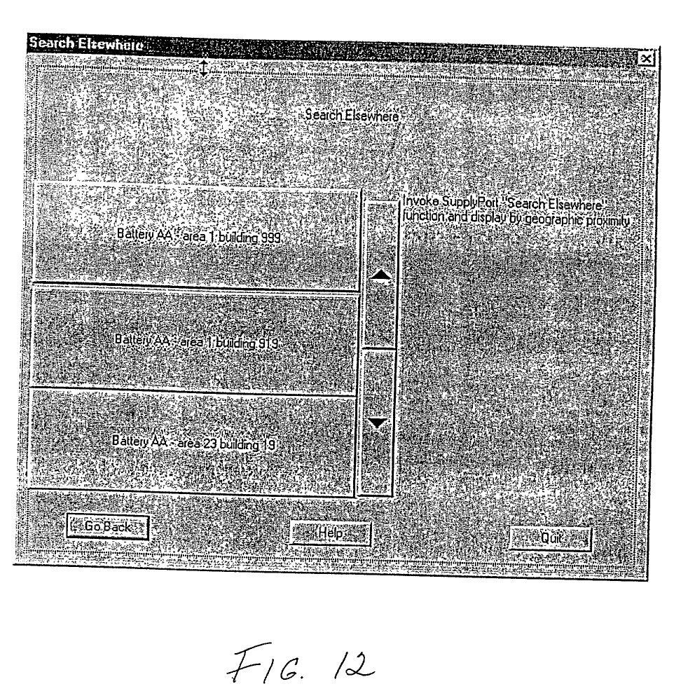

The dispenser enables a user to find the item elsewhere when they did not find the desired item in the dispenser or the point-of-use. The find elsewhere function uses the find item criteria defined above to search all dispensers or a plurality of second point-of-use locations that the user has access to. If the search criteria entered by the user matches more than one dispenser, then a list will appear indicating the item name, location, and current quantity. An example of such a search elsewhere screen is illustrated in FIG. 12. In addition to geographic proximity, the user can also be notified as to the coefficient of effort in getting to the closest dispenser having a desired item. For example, the closest dispenser having the desired item may be up four flights of stairs while another dispenser having the desired item may be on the same floor but further away. Upon notification of the coefficient of effort, the user may prefer to walk further on the same floor than to take the stairs.

Preferably, the find function includes one or more of the following: (1) display find elsewhere button from within the find item screen, (2) support item search by item name, description, part number, or alternate part number, (3) display only matching results from dispensers that the user has access to, and (4) geographic proximity is used when displaying search results.

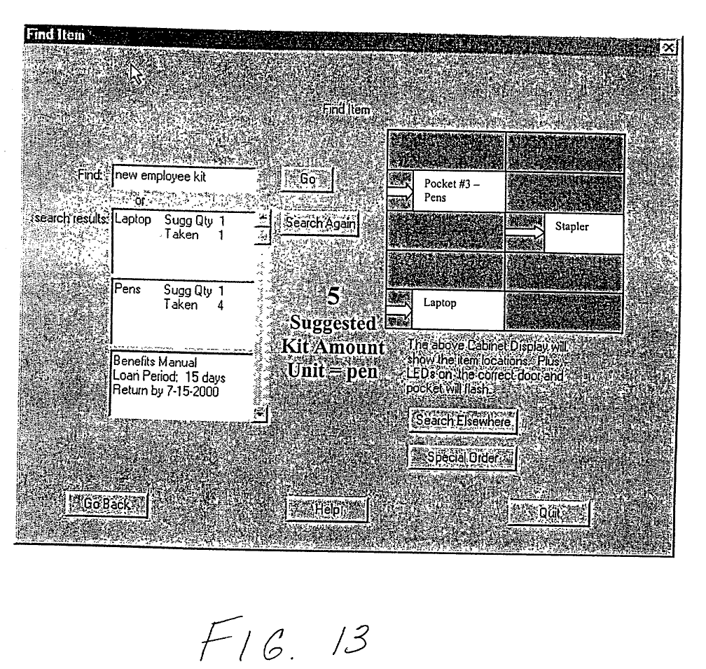

The dispenser preferably includes the ability to designate a kit or subassembly as a collection of two or more items. Specific quantities can be designated for each item in a kit. Each kit is given a unique name. For example, a “New Employee Kit” may consist of a stapler, two boxes of paperclips, and a box of floppy disks. When a user chooses to find an item, the list of items matching the user's search criteria may include kits if the search criteria match the name of any defined kits in the dispenser. If a kit is selected from the list, all locations containing items in the kit will light, and the screen will designate the name and location of all items. If a user then presses the take button for kit items prior to pressing any other take or return buttons, then the default kit quantity will be displayed for the item. The user will then be prompted to remove the designated quantity, and press the take button for the next item in the kit. An example of a kit or subassembly screen is illustrated in FIG. 13.

Preferably, the kit function includes one or more of the following: (1) display any kits that match the user's search criteria in either the find item or find elsewhere functions, (2) if the user is in the find item function and selects a kit, then flash lights for all locations containing items that make up the selected kit, and display the location of each item on the dispenser screen, and (3) if the user is in the find item function and selects a kit, then display the kit quantity as a default quantity for each item where the take button is pressed, until the user presses take for an item that is not part of the kit.

8. Defective Item Return Function

Dispensers preferably include the ability to designate specific locations, such as pockets, as defect pockets. Defect pockets enable the return of defective items. A defect pocket can hold different types of items. When the user presses the return button on a defect pocket, the user will be prompted to select an item from a list of all items that are currently loaded in the dispenser. After the return button is pressed, the interface will prompt for a product allocation code defined for defect return for the selected item. If all defined allocation codes are configured as batch allocation codes, then the dispenser will allow the user to designate the quantity that is being returned as defective. If any of the defined allocation codes are configured as unit allocation codes, then the user will be required to press the return button and enter allocation codes once for each unit being returned. Defect allocation codes are customer-configured, and are defined at both the company level, and optionally at the item level. If defect allocation codes are defined at the item level for the selected item, then the item-specific defect allocation codes are prompted. If no defect allocation codes are defined at the item level, then the companylevel defect allocation codes will be prompted. Examples of defect allocation codes are RMA number, Reason for Return, etc.

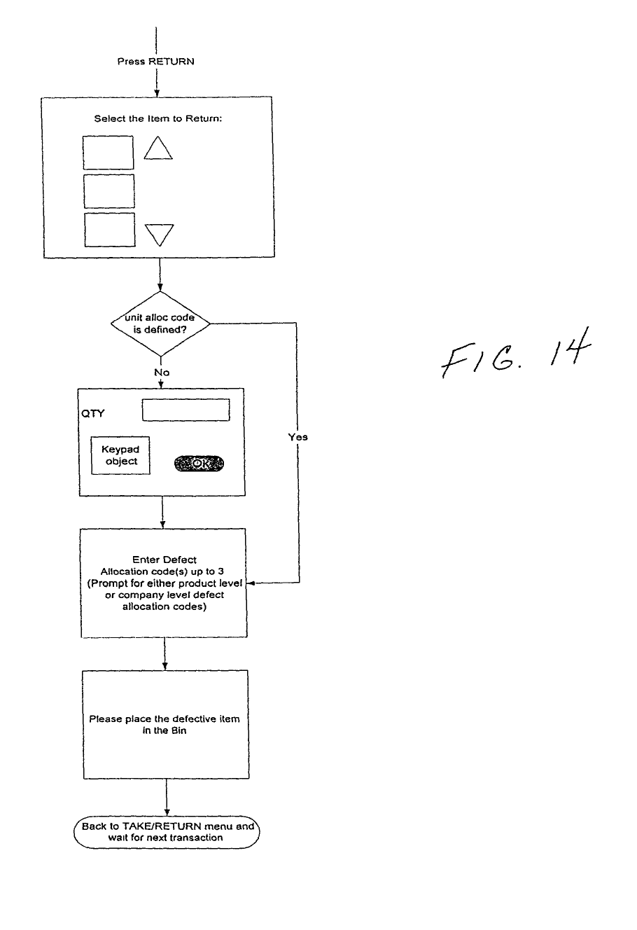

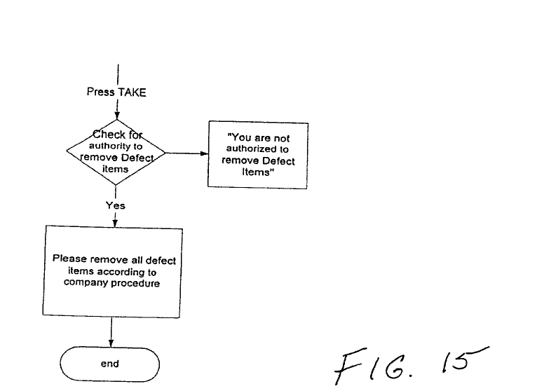

Authorized users can unload defective items from a defect pocket by pressing the take button. If the user is authorized to remove defective items, then the dispenser will confirm that the user wants to remove all items from the pocket. If the user is not authorized to remove defective items, then the interface will display a message telling the user that they are not authorized to remove defective items. Reports can be generated setting forth data on defective items. Examples of flowcharts for the return and removal of defective items are illustrated in FIGS. 14 and 15.

Preferably, the defective item return function includes one or more of the following: (1) allow a location such as a pocket to be designated as a defect return pocket during the pocket load process, (2) prompt for item and item-specific defect allocation codes when the return button is pressed for a defect return pocket, (3) if no item-specific defect allocation codes are defined, prompt for the default company wide defect allocation codes, (4) if all displayed allocation codes are configured as batch allocation codes, allow the user to designate the quantity being returned, (5) if any displayed allocation codes are configured as unit allocation codes, require the user to press the return button and enter allocation codes once for each item being returned, and (6) allow an authorized user to unload all defective items in a defect return pocket by pressing the take button.

9. Quota Function

The dispenser preferably includes the ability to define consumption quotas for individual users or user groups. E-mail notification and/or reporting when quotas are exceeded can be enabled. Specifically, the quota function provides a method of tracking an item dispenser inventory at a point-of-use, the method includes determining a user accessibility, determining a user-specific work type based on the user accessibility, and assigning a consumption quota based on the user-specific work type.

10. Market Research Support Function

The dispenser preferably includes the ability to designate an item as a market research item. If a market research item is removed from a dispenser, a market research response is generated. Preferably, the response, such as a prompt on the screen or an e-mail message, will automatically be generated and communicated to the user asking the user to answer survey questions about the item. For example, the screen may display a video advertisement about the item with survey questions to be answered and sent to the item's manufacturer in real time. Preferably, the market research function includes one or both of the following: (1) when take button is pressed for a market research item, display an item-specific message and logo on the screen, and (2) e-mail functionality to user.

11. Special Order Function

A special order option on the screen is preferably available immediately after log on, and from within the find item screen for items not found or stocked within the dispenser. Preferably, the special order function includes one or both of the following: (1) special order button is present from the find item screen, and (2) if the special order option button is pressed, then all doors will immediately lock, and the special order functionality will be presented to the user. When the special order function is selected, the user is directed to a customer-pre-determined merchant for the special order.

12. Inventory Function

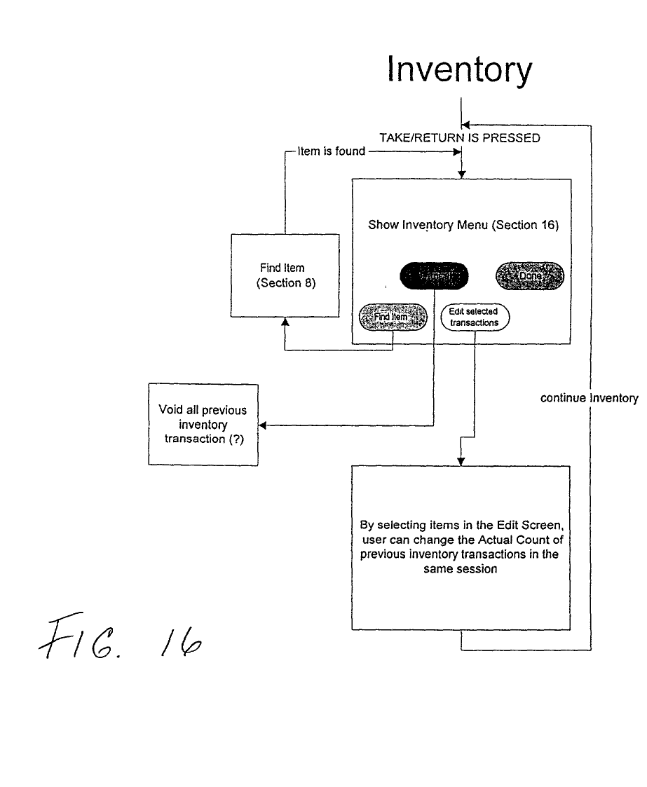

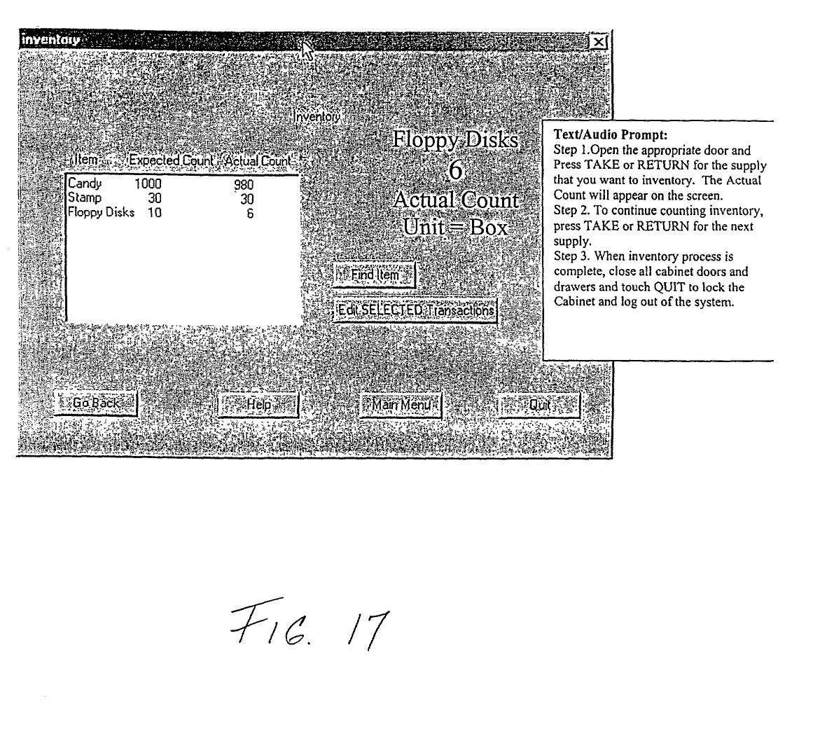

The dispenser enables authorized users to perform a physical inventory, whereby the quantity of items is physically counted by the user, and the actual count is entered into the dispenser. If the expected count differs from the actual count, then a discrepancy will be logged and sent to the server. Examples of a flowchart and screens for this function are illustrated in FIGS. 16 and 17.

Preferably, the inventory function includes one or more of the following: (1) display unit of issue along with expected count and allow user to change count to actual count if necessary, (2) display a list of all inventory transactions performed in a session, (3) allow user to edit a previous inventory transaction by selecting from the list, (4) find item function is available while performing a physical inventory, and (5) no limit on the number of inventory transactions that can be performed in a single session.

13. Refill Function

The dispenser preferably includes a refill function that walks the user through the process in a step-by-step manner. At each step in the process, a screen will indicate what user action should be taken. For example, when the user is prompted to confirm the current count, the screen will read “Count the number of boxes and enter the number now. After entering the count, touch OK”. The next prompt will be “Now enter the total number of boxes that you are refilling in the pocket. Touch OK when you are finished.”

Prior to beginning the refill process, the user has the ability to designate a specific order to refill by selecting an order number from a list of outstanding orders. After beginning the refill process, and optionally selecting an order number, all doors will unlock. In order to refill items in a given location, the user will press the take or return button for the pocket to refill. For example, the following steps occur:

(a) The user is prompted to confirm a current item count. The expected count will be displayed as a default value. If the user changes the default value, then a discrepancy will be logged and sent to the server.

(b) The user will then be prompted to enter the quantity that is being refilled. The applicable unit of measure will be clearly indicated (e.g. dozen, box, etc.) to ensure that the correct entry is made.

(c) If the pocket contains a check-out item, then depending on the type of item contained in the pocket, the user may be prompted to enter specific product allocation codes for each item that is being refilled.

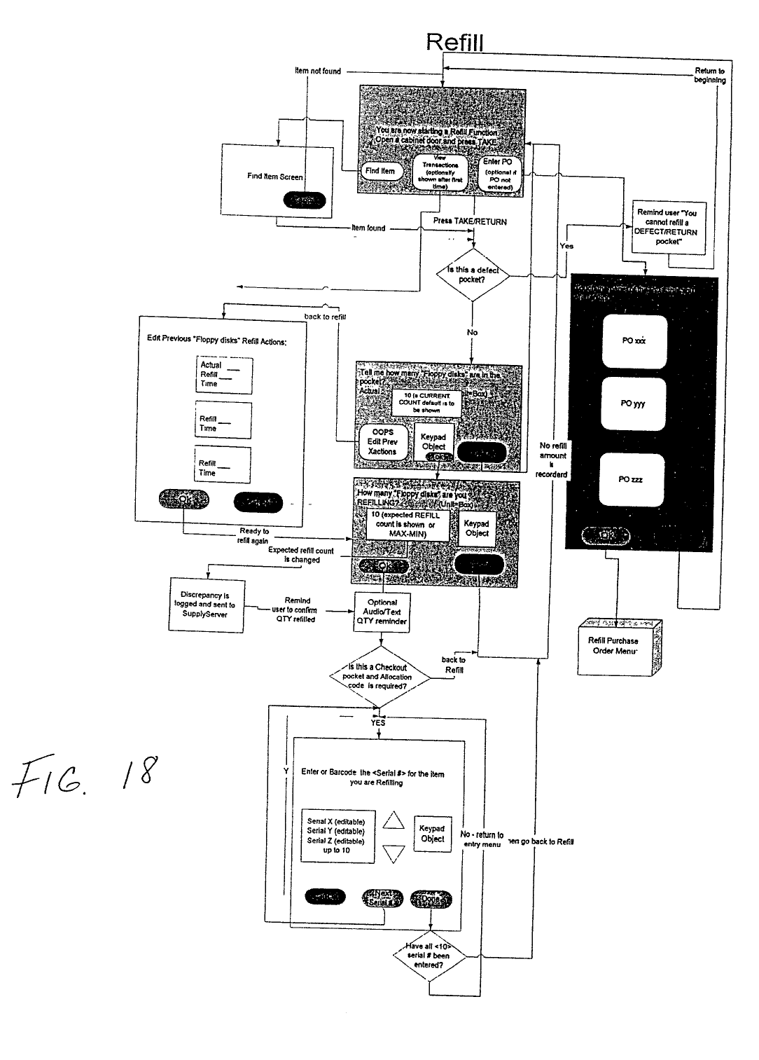

(d) Press the take or return button for another pocket, and repeat from Step (a). An example of a flowchart with screens is illustrated at FIG. 18.

Preferably, the refill function includes one or more of the following: (1) light up all pockets on order below a minimum quantity or below a critical quantity, (2) immediately after user selects refill function, allow user to designate that a specific order number is about to be refilled, (3) find item function is available to help user locate specific items throughout the refill process, (4) do not allow a defect pocket to be refilled, (5) display unit of issue when prompting to confirm current count or to enter quantity to refill, (6) when prompting for entry of quantity to refill, display the order quantity if an order number was selected, (7) audio and text reminder to confirm quantity of items refilled, (8) allow user to edit previous refill transaction by selecting it from a list of previous refill transactions, the user will be able to edit both the current count confirmation and the amount refilled, (9) allow user to cancel the current refill transaction even if the current count has already been performed, (10) support all functionality necessary to refill a check-out item, and (11) support use of a barcode scanner to scan serial numbers on items.

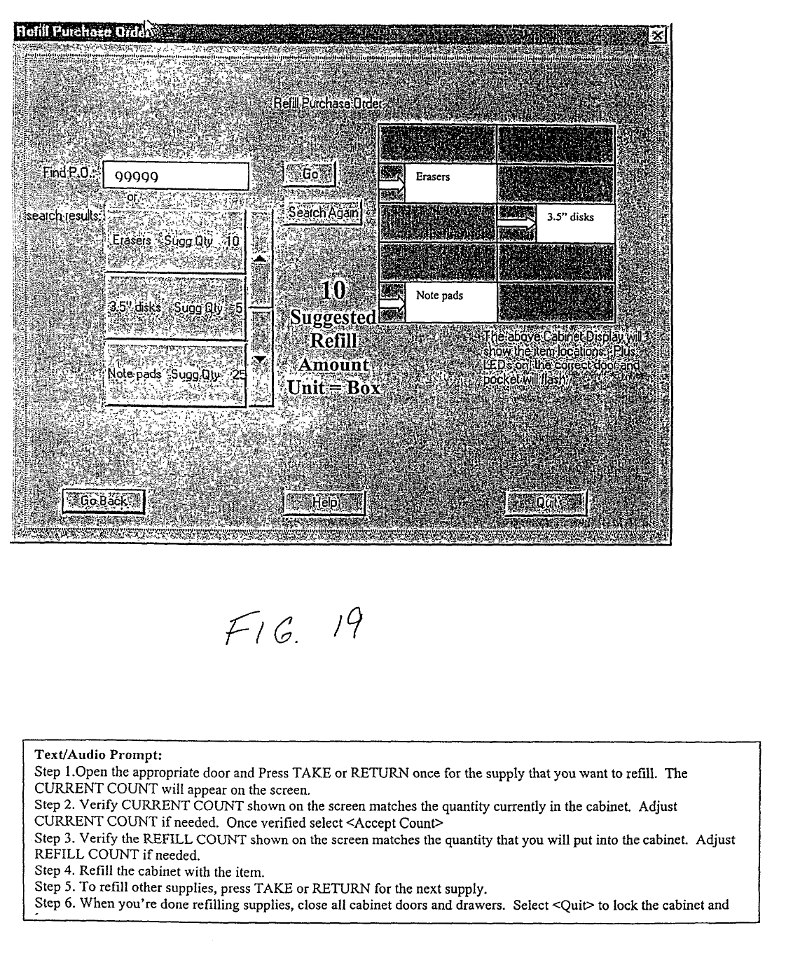

After a user selects the refill function, the user preferably has the option of associating the current refill activity with an outstanding purchase order. The user has the ability to identify a specific order for refill by selecting the order number from a list of outstanding orders that includes order number, order date, and vendor. If the user selects an order from the list, then a new list will appear indicating all of the items associated with the selected order. Lights will flash under the locations of all items that are part of the selected order. When a take or return button is pressed for a flashing pocket, the expected refill amount from the order will be displayed as a default value when the user is prompted to enter a refill amount. An example of such a screen is illustrated in FIG. 19.

Preferably, the purchase order refill function includes one or more of the following: (1) allow user to select an order number from a list of outstanding orders immediately after beginning the refill process, (2) only show orders in the list that have not been refilled at the dispenser, and have not expired—orders expire after a configurable time period has elapsed, (3) if an order number is selected, flash all applicable pockets, and display a graphic on the screen indicating the location of items comprising the selected order, (4) if the take or return button is pressed for a flashing pocket, prompt for the order quantity as a default refill quantity, and (5) track orders that are not completely refilled, for example, if ten pens were ordered, but restocker only has eight on hand, then dispenser will note that there are still two pens remaining to be refilled.

Check-out items are refilled in a similar manner to other items, with one exception. If a check-out item is configured to prompt for a unit allocation code, then the screen displays a prompt to the user to enter allocation code information for each item being refilled in the dispenser. For example, if an item were configured to track by serial number, then the interface would prompt the user to enter serial numbers for all items being refilled. Preferably, the refill function includes one or more of the following: (1) prompt user to enter the unit allocation codes for each item being refilled if the item is configured to track by unit allocation code, (2) support data entry of allocation codes in a batch format to allow for streamlined entry of multiple items during the refill process, and (3) if track by unit allocation code is not enabled, then the refill process for the check-out item should be identical to the process for non-check-out items.

If the dispenser is stocked with items from multiple vendors, a given vendor will only be given access to the items they are responsible for stocking.

14. Pocket Configuration Function

Authorized users are able to configure dispenser pockets at the dispenser. Once a user initiates pocket configuration, the doors that are authorized to open to the user will unlock, and pockets are selected for configuration by the user pressing the take or return button associated with the pocket to configure. If the selected pocket is currently loaded with an item, then the user will have the ability to edit the current pocket, or clear the current pocket. If the selected pocket is not currently loaded, then the user will have the opportunity to load the pocket by designating an item and related inventory information. A defect return pocket can also be configured.

Once a user initiates the pocket configuration process and presses a take or return button for a pocket that is not currently loaded, the dispenser will guide the user through loading items into the pocket, or designating the pocket as a defect return pocket. The user will be prompted to select an item from a list, or to indicate that the pocket will be a defect return pocket. If an item is selected from the list, then the following attributes will preferably be prompted: physical maximum (maximum number of units that can be stored in the pocket), maximum (maximum number of units typically stored in the pocket when pocket is refilled, pocket is typically refilled to this value), minimum (when inventory level falls at or below this level, pocket is to be considered low on inventory—when inventory falls below minimum, a refill order is typically generated), critical (when inventory level falls at or below this level, inventory is to be considered critically low), current (current number of units stored in the pocket), and priority (low, normal, or high).

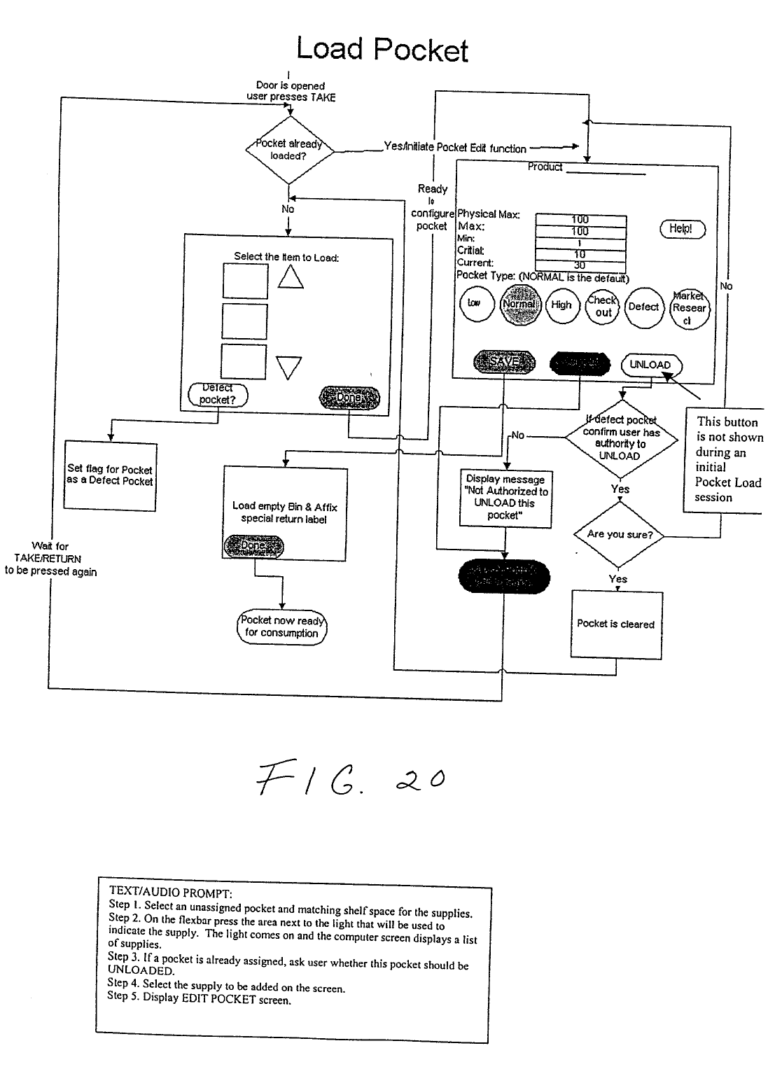

An example of a flowchart and screens is illustrated at FIG. 20.

Preferably, the load pocket function includes one or more of the following: (1) after the take or return button is pressed for an empty pocket, prompt user to select an item from a list, or designate the pocket as a defect return pocket, (2) if an item is selected, prompt the user for all attribute values, (3) do not allow maximum, minimum, critical, or current to exceed physical maximum, (4) do not allow minimum to exceed maximum, (5) do not allow critical to exceed minimum, (6) display a default pocket priority as the priority assigned to the item and allow the user to change the default priority, (7) if item being loaded is a check-out item, then prompt for specific product allocation codes, (8) do not display or prompt for pocket attributes if the pocket is defined as a defect return pocket, and (9) prompt user to load the designated quantity and affix a pocket label after all applicable attributes have been provided and display the unit of issue to ensure that the correct quantity of items is loaded.

If the user presses the take or return button for a pocket that is currently loaded, then the user can edit the attributes. Preferably, the edit pocket function includes one or more of the following: (1) after the take or return button is pressed for a loaded pocket, allow the user to edit the attributes if the pocket is not a defect return pocket, (2) do not allow maximum, minimum, critical, or current to exceed physical maximum, (3) do not allow minimum to exceed maximum, (4) do not allow critical to exceed minimum, (5) do not display or prompt for pocket attributes if the pocket is defined as a defect return pocket, and (6) allow the user to clear the pocket and provide confirmation to the user prior to clearing the pocket.

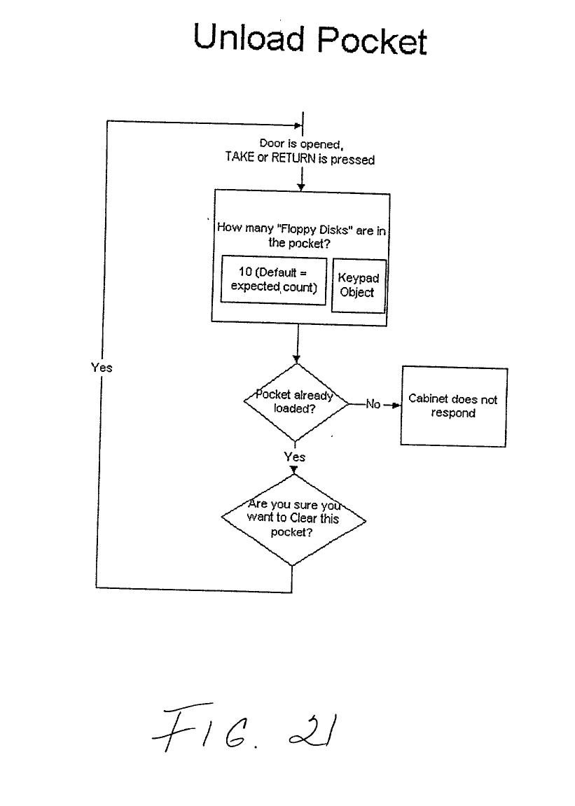

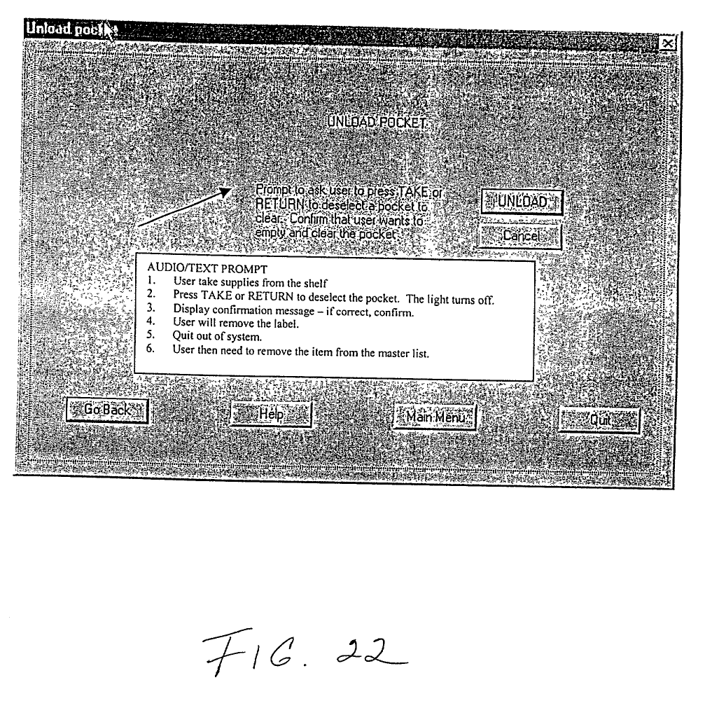

If a user presses a take or return button for a pocket that is currently loaded, then the user can clear the pocket. Clearing a pocket deletes all information about the current item that is loaded in the pocket. Once a pocket is cleared, it can be loaded with a new item, or it can be configured as a defect return pocket. For example, see the flowchart and screen configuration as illustrated in FIGS. 21 and 22. Preferably, the clear pocket function includes one of more of the following: (1) after the take or return button is pressed for a loaded pocket, allow the user to clear the pocket, (2) require the user to explicitly confirm clearing of the pocket, (3) once a pocket is cleared, prompt the user to remove items from the pocket and remove the pocket label, and (4) users will do one final count of inventory inside the pocket and move the items to another location based on company procedure.

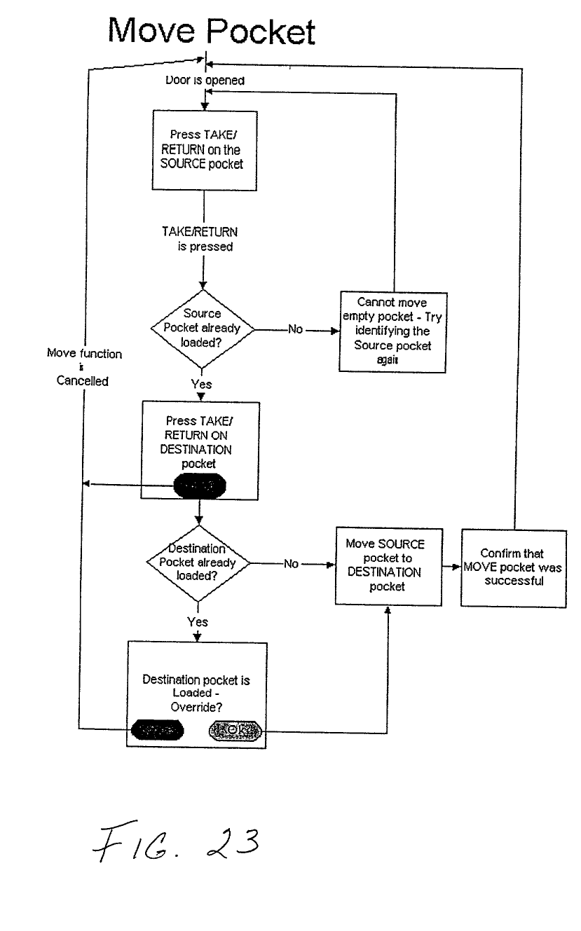

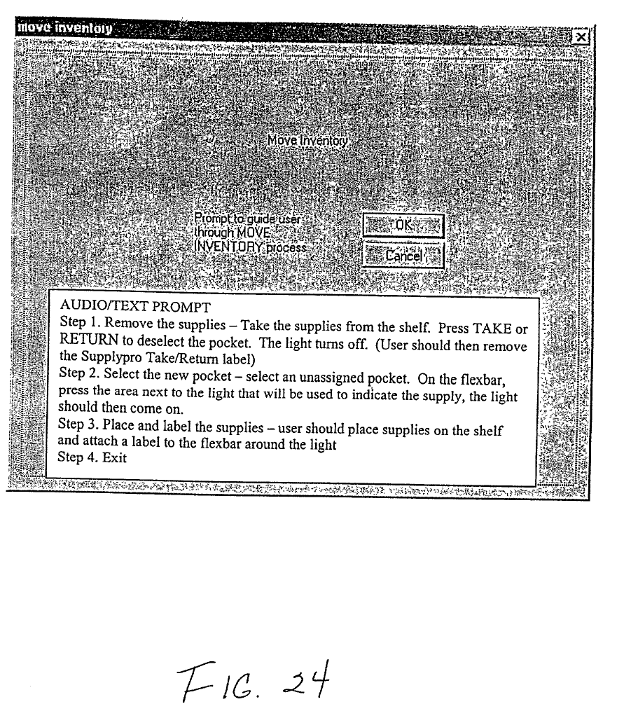

The dispenser interface allows the user to enter a special mode wherein the user can move items from one pocket in the dispenser to another pocket. A flow chart of this function is illustrated in FIG. 23 and a sample screen at FIG. 24. Preferably, the move pocket function includes one or more of the following: (1) when in move pocket mode, prompt the user to designate a source pocket and destination pocket by pressing the applicable take or return buttons, (2) if a valid source pocket and destination pocket are designated, then move all data associated with the source pocket to the destination pocket, then clear the source pocket, (3) if the user selects a source pocket that is not loaded, notify the user and abort the move, and (4) if the user selects a destination pocket that is currently loaded, ask the user if the destination pocket should be cleared, and confirm.

15. Help Function

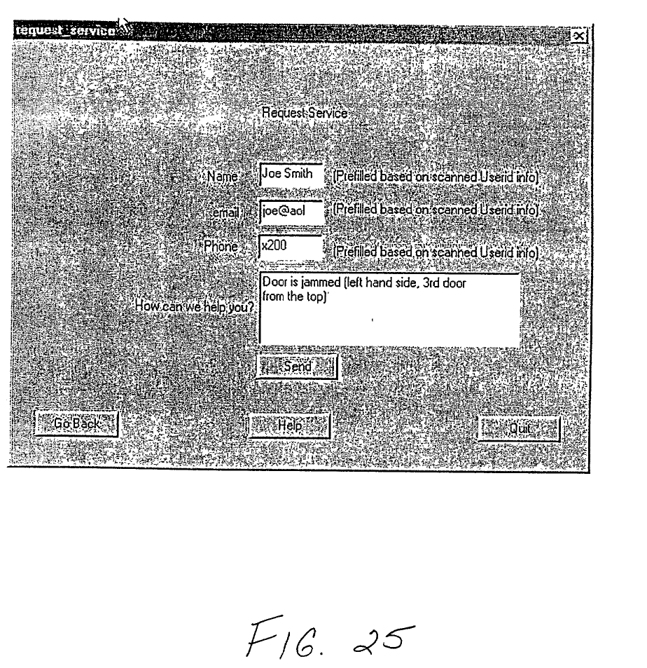

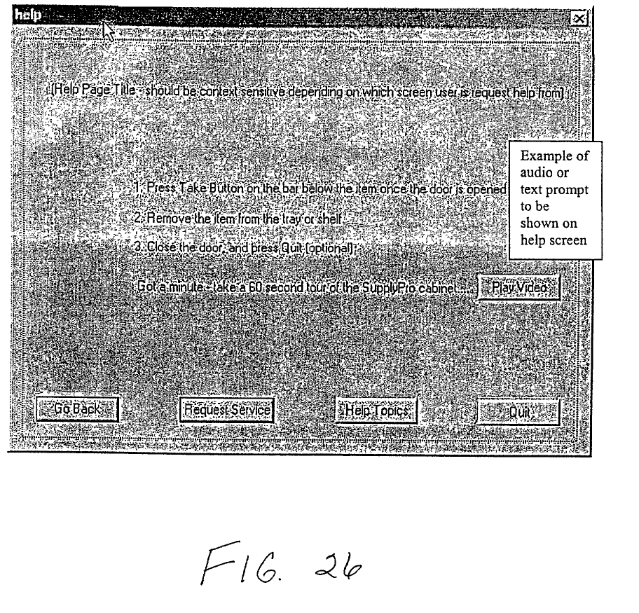

The dispenser interface allows users to send a help request or request for service from the dispenser. When help is requested, the dispenser interface will display context-sensitive instructions on how to perform the current activity. In addition to context-sensitive help, the user is able to request service from the log in screen, even if the user has not logged in. This allows a user to easily report any dispenser problems. When a user requests service, the user is prompted for a name, e-mail address, phone number, and problem description. Examples of request service screens are set forth at FIGS. 25 and 26. Preferably, the help function includes one or both of the following: (1) provide buttons as applicable throughout dispenser screens to allow a user to request help, and (2) provide a button from the log in screen to allow any user to request service, the service request will be automatically be routed to the appropriate destination.

16. Communication With Server Function

The dispenser is able to communicate with a server and transfer transaction information bi-directionally. The dispenser supports the TCP/IP, modem, and direct cable connectivity. Preferably, the communications function includes one of more of the following: (1) support fault-tolerant communications via modem, (2) support fault-tolerant communications over the public Internet via TCP/IP, (3) support direct communications with a Portable CommServer via direct cable connection, and (4) employ application-specific encryption to ensure that data is protected if intercepted.

The dispenser and interface can also be integrated with a customer's existing or legacy software such as software available from SAP and PeopleSoft. Such integration can be implemented using technologies such as XML or EDI.

17. Edit and Delete Function

The dispenser enables the following transactions. An item edit transaction results in a new item being added to a dispenser's database, or an existing item being updated. The item will then be available for pocket loading. An item delete transaction results in an item being deeted from the dispenser database. An item purge transaction results in all items being deleted from the dispenser database. A user edit transaction results in a user being added to a dispenser's database, or an existing user being updated. A user delete transaction results in a user being deleted from the dispenser database. A user purge transaction results in all users being deleted from the dispenser database.

An allocation code header (ACH) defines what type of allocation code is prompted by the dispenser, and whether the allocation code is prompted on log in, or after a take button is pressed. In addition, the ACH defines the label that will be displayed to the user, and the type of validation and user entries permitted. An ACH edit transaction results in an ACH being defined and added to a dispenser's local database, or an existing ACH being updated. An ACH delete transaction will result in an ACH being deleted from the dispenser database. When an ACH is deleted, all allocation codes will be purged. An ACH purge transaction results in all ACH records and allocation codes being deleted from the dispenser database.

18. Consignment Function

The dispenser and interface support a consignment function that provides a method of tracking the dispenser system. The method involves determining an accessibility of a user, determining a user-defined consignment session based on the accessibility of the user. Thereafter, the method further involves marking a consignment inventory when there is a transaction during the consignment session, and transmitting the consignment inventory to a consignment database. The consignment function also supports the maintenance, the reporting, and the billing of consignment inventory. The consignment function helps a vendor receive adequate billing information and an inventory information.

B. Hardware Specification

The architecture supporting the dispenser and interface functionality set forth herein preferably includes a Pentium X and/or other Intel-compatible hardware using a Windows NT Operating System.

C. Dispenser Specification

How items are dispensed and how much control is exercised depends in large part upon the item being dispensed and the company at which the items are being dispensed. Various approaches are described below and can be used in various combinations within a dispenser.

1. Controlled vs. Non-Controlled Access

For certain items, for example perhaps office supplies such as pens and pencils, the dispenser does not be need to control access, meaning every user has access to those items and no locking doors or other protection devices are necessary. Further, the company may not even need a user's identification before the items are removed. However, tracking inventory is still necessary and items taken and returned still need to be tracked.

For items needing controlled access, in addition to locking doors, other approaches can be utilized. For example, items may be located in a pull out bin of various sizes wherein each bin has thereon or therein a sensor, switch or lock that is releasable to provide approved user access to the items therein.

2. Dispenser Notification of Access

In addition to or in place of controlled access, devices can be employed in various locations throughout the dispenser to passively indicate that a user has had access to a particular location. These approaches still require a quantity of items taken or returned to be determined. Examples of these devices include, among other things, the following.

a. A wand is mounted across a pocket of the dispenser. As a user reaches for the item desired, the wand is moved indicating access was had by a user.

b. A light beam or curtain, such as an infrared beam, could be employed across a single item dispensing location or across all dispensing locations within the dispenser. The beam is generated such as by an LED and the light received by a sensor. Breaking of the beam or curtain by a user is identified with coordinates which indicates the user having access to certain items.

c. A bracelet having a smart chip therein could be worn by a user. An RF antenna adjacent each item dispensing location receives a signal from the bracelet to indicate what items where accessed. Alternatively, such a chip could be sewn into a uniform sleeve for the same purpose.

d. An item may be located behind glass. If the glass is broken, the dispenser would be informed. Such an approach is applicable to safety equipment that needs immediate replacement.

e. A magnetic card reader. A credit card type device is hung on a lanyard and the cabinet includes a magnetic card reader or other identification sensing device. The credit card would be placeable into the card reader by the user and held in the card reader while the user accesses the cabinet and removes the desired items. The transactions would then be recorded on the card.

f. A fluid level sensor. If a fluid is to be dispensed or removed from the cabinet, the cabinet can be configured to include a container, such as a drum, having therein a fluid level sensor. As fluid is removed from the cabinet by a user, the level sensor would indicate the amount of fluid removed as well as the amount remaining for restocking purposes.

g. A radio frequency antenna and a radio frequency identity chip on the item. A radio frequency (RF) identity chip or smart chip is attached to the items in the dispensing cabinet, and a radio frequency antenna is installed in the dispensing cabinet. Therefore, the removal of the items from the dispensing cabinet can be recorded by the RF antenna.

h. A scanner. A handheld scanner or any other scanner can be used to scan in the items being removed.

i. A scale. If the items to be removed is measured by weight, nails for example, an appropriate sensor would be a scale, such as an electronic scale. As the items are removed from the dispensing cabinet by a user, the scale sensor would indicate the amount of weight lost as well as the amount remaining for restocking purposes.

j. Pull out bins could be monitored as to how far the bin was pulled outwardly. Depending upon the size of the items in that bin, a distance traveled by the bin could be correlated with an item quantity. The quantity could also be verified by the user.

k. Each item in a location, shelf or bin could be tagged with a smart chip. When the item is removed, such as by passing by an RF antenna, the dispenser would know that that item had been removed or, alternately, had been returned. An example of such smart chips are those available from Single Chip Solutions.

3. Tracking Items Taken or Returned

One approach to tracking inventory in the dispenser is to have the user press take and return buttons to indicated quantity. This approach is dependent upon the user remembering to do so. As explained above, the dispenser interface can prompt the user to press the appropriate buttons or can provide an audio prompt to remind the user to do so. In any event, this approach to tracking inventory is an active approach that requires the user to provide the necessary quantity information. Other active approaches include a keypad, barcode scanner or a voice recognition system so that a user can verbally state a quantity taken or returned.

1. A method of tracking an item dispenser inventory at a point-of-use, the method comprising:
establishing a network of computerized item dispensers, each dispenser containing inventory;
establishing a computer data center, the data center being in electronic communication with the network;
establishing allocation codes within the data center, the allocation codes limiting the extent to which inventory is allowed to be withdrawn from the dispensers;
identifying a user at one of the dispensers; and
allowing the user to reconfigure the allocation codes from the one of the dispensers.

2. The method of claim 1, further comprising:
prompting a user to enter a login allocation code.

3. The method of claim 1, further comprising:
displaying a user-specific default value for an allocation code.

4. The method of claim 1, further comprising:
prompting a user to enter a product allocation code.

5. The method of claim 4, further comprising:
prompting the user to remove a quantity of items; and
prompting the user to enter a quantity of the removed items.

6. A method of tracking an item dispenser inventory at a point-of-use, the method comprising:
determining a user;
receiving a request for an item from the user;
determining an item inventory based on the request;
determining whether a special order is necessary based on the item inventory; and
directing the user to a customer-pre-determined merchant for the special order.

7. The method of claim 6, wherein the customer-pre-determined merchant is a web-based merchant.

8. A method of tracking an item dispenser inventory at a point-of-use, the method comprising:
determining a user accessibility;
receiving at an item dispenser a request from the user for an item;
determining whether the item is present at the point-of-use item dispenser;
searching whether the item is present at a secondary item dispensers when the item is not present at the point-of-use item dispenser; and
displaying the secondary item dispenser when the item is present at the secondary item dispenser.

9. The method of claim 8, further comprising:
prompting a user to select an item from a scrolling list if more than one item is present at the secondary item dispenser.

10. The method of claim 9, further comprising:
flashing the secondary item dispenser when the item is selected.

11. The method of claim 8, further comprising:
prompting a user to special order when the item is not present at any secondary item dispenser.

12. A method of tracking an item dispenser inventory at a point-of-use, the method comprising:
determining a user accessibility;
determining whether an item is to be checked in or out by the user;
assigning a loan period when the item is checked out by the user;
configuring a first customer-pre-defined time period when the checked-out item is delinquent; and
assigning the checked-out item a consider-consumed status when the checked-out item is not returned after a second customer-pre-defined time period.

13. The method of claim 12, further comprising:
charging the consider-consumed item to the user.

14. The method of claim 12, further comprising:
notifying the user of the loan period when the user logs in.

15. The method of claim 12, further comprising:
preparing reminders and reports on a delinquent user.

16. A method of tracking an item dispenser inventory at a point-of-use, the method comprising:
determining a user accessibility;
determining a defective return location based on the user accessibility at the point-of-use; and
returning a defective item to the defective return location.

17. The method of claim 16, further comprising:
designating a quantity of the defective item.

18. The method of claim 16, further comprising:
allowing an authorized user to unload the defective items.

19. A method of tracking an item dispenser inventory at a point-of-use, the method comprising:
determining a user accessibility;
designating an item as a market research item;
determining whether the market research item is removed by the user;
generating a market research response; and
communicating the market research response to the user.

20. The method of claim 19, wherein the market research response is a survey.

21. The method of claim 19, wherein the market research response includes displaying a video advertisement.

22. The method of claim 19, wherein the market research response is a receipt.

23. A method of tracking an item dispenser inventory at a point-of-use, the method comprising:
determining a user accessibility;
determining a user-specific work type based on the user accessibility; and
assigning a consumption quota based on the user-specific work type.

24. The method of claim 23, wherein the consumption quota defines a quantity of items to be checked out.

25. The method of claim 23, wherein the consumption quota defines a customer-defined check out period.

26. A method of tracking an item dispenser inventory at a point-of-use, the method comprising:
determining a user accessibility;
determining a user-defined consignment session based on the user accessibility; and
marking a consignment inventory when there is a transaction during the consignment session.

27. The method of claim 26, further comprising:
reporting the consignment inventory.
